(19) United States
(12) Patent Application Publication
(10) Pub. No.: US 2026/0256173 A1
(43) Pub. Date: Sep. 3, 2026

(54) CRUNCHY MEAT JERKY

(71) Applicant: Lucas Alfredo Prado, Doral, FL (US)

(72) Inventor: Lucas Alfredo Prado, Doral, FL (US)

(21) Appl. No.: 19/652,834

(22) Filed: Apr. 20, 2026

Related U.S. Application Data
(63) Continuation of application No. 17/970,179, filed on Oct. 20, 2022.
(60) Provisional application No. 63/272,350, filed on Oct. 27, 2021.

(51) Int. Cl. A23L 13/70; A23L 5/10; A23L 13/10; A23L 13/40; A23L 13/60

(52) U.S. Cl. CPC A23L 13/70; A23L 5/10; A23L 13/10; A23L 13/428; A23L 13/67

(57) ABSTRACT

A method for preparing meat jerky comprises (a) cooking the meat in an aqueous salt solution; (b) shredding a meat into shredded meat; (c) marinating the shredded meat with an aqueous solution of acid and salt; (d) shredding the shredded meat a second time to form a twice shredded meat; and (e) drying the twice shredded meat. A meat jerky that is at least one of crisp, crunchy, or friable is also disclosed, and can be prepared by the method.

### CROSS REFERENCE TO RELATED APPLICATION

This application is a continuation of U.S. patent application Ser. No. 17/970,179, filed Oct. 20, 2022, which claims benefit of U.S. Provisional Application No. 63/272,350 filed Oct. 27, 2021, each of which is incorporated herein by reference in its entirety.

### BACKGROUND

The present disclosure relates methods of preparing meat jerky and meat jerky prepared by the method. The meat jerky is at least one of crisp, crunchy, or friable.

Meat jerky is a widely popular dehydrated and savory meat product in a convenient ready-to-eat form. It is said to have been originated by Native Americans as a method for preserving beef. It is now a popular food product in North and South America, Europe, Japan, and elsewhere. Meat jerky is a nutritious snack due to its high protein content. Moreover, it does not require refrigeration, is easy to store for long periods of time, and is easy to transport. Therefore, it is an ideal snack to take along on vacations and outdoor leisure activities. It can be stored in a purse, pouch, or backpack, and is easily taken out, distributed, and eaten as needed.

Meat jerky is prepared by cutting raw meat into thin strips with much of the fat trimmed off, and then drying. Drying is done in an oven at relatively low heat so that the meat is not cooked, or by sun-drying. Salt, preservatives, and marinades can be added. By keeping the moisture content relatively low, microorganism growth is slowed, and spoilage is prevented, especially if the meet jerky is stored in airtight packaging. Accordingly, meat jerky is generally understood to be a meat that has been dried to a moisture content of less than about 40 wt. %. Many types of meat may be “jerked” including but not limited to chicken, beef, venison, lamb, fish (e.g., tuna and salmon), pork, turkey, duck, alligator, ostrich, buffalo, pheasant, rabbit, veal, and elk.

### SUMMARY

For a more complete understanding of this disclosure, reference is now made to the following brief description, taken in connection with the accompanying drawings and

### DETAILED DESCRIPTION

A method for preparing meat jerky comprises (a) cooking a meat in an aqueous salt solution; (b) shredding the meat into a shredded meat; (c) marinating the shredded meat with an aqueous solution of acid and salt; (d) shredding the shredded meat a second time to form a twice shredded meat; and (e) drying the twice shredded meat. The meat jerky prepared by the method is at least one of crisp, crunchy, or friable.

Additional embodiments and features of the present method for preparing meat jerky and meat jerky prepared by the method are described in the Detailed Description. Reference is also made to the Drawings and Detailed Description for a better understanding of the advantages of the present method for preparing meat jerky, and the meat jerky prepared by the method.

### BRIEF DESCRIPTION OF THE DRAWINGS

For a more complete understanding of this disclosure, reference is now made to the following drawings:

FIG. 1 is a photo of the meat jerky.

FIG. 2 are photos of various cuts of beef suitable for making the meat jerky.

FIG. 3 depicts force-time graphs for KRAVE, JACK LINK'S, Jerky A, and Jerky B.

FIG. 4 is a photo of the TA-65 Multiple Puncture Rig used in collection of force-time graphs for the meat jerky.

### DETAILED DESCRIPTION

For the sake of brevity, conventional techniques related to the preparation of meat jerky, for example brining, shredding, marinating, and drying, may or may not be described in detail herein. Moreover, the various method steps described herein can be incorporated into a more comprehensive procedure or method having additional steps or functionality not described in detail herein. In particular, various steps in preparation of meat jerky are known and so, in the interest of brevity, many conventional steps may only be mentioned briefly herein or may be omitted entirely. Any details related to the present method that are well-known to the skilled person in the art may be considered inherent in the method.

Beef jerky is popular for its hard chewiness. However, it was not a good food for people with bad teeth and elderly people because of its hardness. Therefore, in recent years, soft forms of beef jerky have been developed to make it easier to chew. A crisp and crunchy form of meat jerky is a highly desirable alternative to chewy meat jerky. A crisp and crunchy meat jerky would not only address the problems associated with hard, chewy beef jerky, but would provide a healthy alternative to unhealthy snacks such as potato chips, tortilla chips, fried pork rinds, and related snacks. To further enhance its healthiness, the meat jerky should be free of monosodium glutamate, nitrates, nitrites, and other preservatives. As a healthy snack, it should also be low in sodium, fat, and carbohydrates.

Disclosed herein is meat jerky and methods for making meat jerky. Advantageously, the meat jerky prepared by the method has a crisp and crunchy texture. The meat jerky prepared by the method is friable, and is therefore much easier to chew than prior art beef jerky, especially for individuals with poor teeth. Moreover, the meat jerky prepared by the method is a healthy alternative to crisp and crunchy snacks that are unhealthy, such as potato chips, tortilla chips, and related snacks. Further enhancing its healthiness, the meat jerky is free of or substantially free of monosodium glutamate, nitrates, nitrites, and other preservatives. Moreover, unlike potato chips, tortilla chips, and related snacks, it is also low in at least one of sodium, fat, or carbohydrates.

Thus, a method for preparing meat jerky comprises: (a) cooking a meat in an aqueous salt solution; (b) shredding the meat into shredded meat; (c) marinating the shredded meat with an aqueous solution of acid and salt; (d) shredding the shredded meat a second time to form a twice shredded meat; and (e) drying the twice shredded meat. Any kind of meat can be utilized, e.g., chicken, beef, venison, lamb, goat, pork, turkey, duck, fish (e.g., tuna or salmon), alligator, ostrich, buffalo, pheasant, rabbit, veal, or elk. In some embodiments, the meat comprises beef and the meat jerky comprises beef jerky. When the meat is beef, the beef can be, for example, at least one of beef round roll, silverside, leg of beef, topside, thick flank, tenderloin, chuck, shank, round, or sirloin. The meat can be a lean meat. The lean meat can contain less than 30%, less than 25%, less than 20%, less than 15%, less than 10%, or less than 5% fat. In some embodiments, the lean meat is beef containing less than 10% fat.

The meat is cooked in an aqueous salt solution prior to shredding the meat into shredded meat. This step is sometimes referred to as “brining” and can be done at ambient pressure, or at higher than ambient pressure in a pressure cooker. Therefore, the cooking can be conducted at a temperature of from about 50 to about 150° C., preferably from about 75 to about 125° C., and more preferably from about 90 to about 110° C. In some embodiments, the cooking is conducting at the boiling point of the aqueous salt solution. The cooking can be conducted for from about 1 to about 24 hr, preferably from about 1 to about 15 hr, more preferably from about 2 to about 12 hr, and still more preferably from about 2 to about 8 hr. In some embodiments, the cooking is conducted for 6 to 7 hr. The optimal temperature and time for cooking can depend on, for example, the amount of meat, toughness of the meat, ambient temperature, and other factors.

The shredding is done to divide the raw meat into individual bite-sized myofibrils, or “fibers”. The shredding is also serves to separate a least a portion of fat and at least a portion of nerves from the meat jerky. The fibers can be less than 5 centimeters (cm) in length (short fibers), from 5 to about 10 cm in length (medium fibers), or from about 10 cm to about 25 cm in length (long fibers). In some embodiments, the meat is beef comprising a combination of short fibers of less than 5 cm in length and long fibers of 5 cm to about 10 cm in length.

After shredding, the meat is mixed with and marinated with an acid and salt. In some embodiments, the salt is table salt, or sodium chloride. Curing salt, also known as “pink salt” can also be used. Curing salt is a mixture of sodium chloride and sodium nitrite, and contains a red dye to distinguish it from table salt, hence the pink color. Curing salt is used in the preparation of ham, bacon, pastrami, corned beef, and other cured meats. In other embodiments, table salt, not curing salt, is used. In these embodiments, the meat jerky is free of or substantially free of sodium nitrite. The amount of salt is from about 0.1 to about 50 g per kg meat, preferably from about 1 to about 25 g per kg meat, and more preferably from about 5 to about 25 g per kg meat. In some embodiments, the amount of salt is about 10 to about 30 g per kg meat.

Marinating the meat with salt draws moisture out of the meat by osmosis. Therefore, the water activity of the meat is reduced to the point where chemical and enzymatic reactions in the meat and in microbes residing in the meat are inhibited. Thus, under these conditions, the microbes cannot grow, and spoilage is prevented. More water is removed in the subsequent drying step. The water activity (a w) of a food is the ratio between the vapor pressure of the food itself, when in a completely undisturbed balance with the ambient air, and the vapor pressure of distilled water under identical conditions. For example, a water activity of 0.80 means the vapor pressure of the food is 80 percent of that of pure water. A water activity of less than or equal to 0.85 is desirable to inhibit the growth of bacteria, yeasts, and mold. In some embodiments, the meat jerky has a water activity of less than or equal to 0.85, 0.50, 0.10, or 0.01.

In some embodiments, the acid is derived from a citrus fruit or other acidic fruit, or is at least one of vinegar, acetic acid, citric acid, lactic acid, gluconic acid, succinic acid, tartaric acid, fumaric acid, ascorbic acid, pyrophosphoric acid, or salts thereof. Vinegars can be utilized as a source of acetic acid. Vinegars are made from various fruit wines. The vinegar can be, for example, at least one of apple cider vinegar, blackcurrant vinegar, raspberry vinegar, quince vinegar, tomato vinegar, persimmon vinegar, jujube vinegar, wolfberry vinegar, kiwifruit vinegar, coconut vinegar, nipa palm vinegar, or balsamic vinegar. The acid can also be, for example, at least one of lemon juice, lime juice, orange juice, grapefruit juice, pineapple juice, tomato juice, or powders thereof. Buttermilk or yogurt can be utilized as sources of lactic acid. In some embodiments, the acid is citric acid. The acid serves to tenderize the meat by breaking down its protein fibers. Tenderizing the meat allows it to become crisp and crunchy upon drying, rather than hard and chewy. The amount of acid can be from about 0.01 to about 100 g per kg of meat, preferably from about 0.1 to about 10 g per kg of meat, and more preferably from about 0.1 to about 5 g per kg of meat. In some embodiments, the amount of acid is from about 0.1 to about 1 g per kg meat. The acid amount should be high enough to tenderize the meat, but low enough to have no adverse effects on the sensory properties of the meat, i.e., taste, smell, and appearance. The acid can be added neat, i.e., without dilution. The acid can also be added as a solution in water. The amount of acid in aqueous solution can be from about 0.01 to about 10 wt. %, preferably from about 0.1 to about 5 wt. %, and more preferably from about 1 to about 3 wt. %, based on the total solution weight.

The marinating can be conducted in a refrigerator at a temperature of from about −10 to about 20° C., preferably from about −10 to about 20° C., more preferably from about −5 to about 15° C., more preferably from about 0 to about 10° C., and still more preferably from about 0 to about 5° C. The marinating can be conducted for from about 0.5 to about 48 hr, preferably from about 1 to about 24 hr, more preferably from about 5 to about 20 hr, and still more preferably from about 8 to about 15 hr. The optimal temperature and time for marinating can depend on the weight of the meat and other factors.

The drying can be conducted in an oven at a temperature of from about 60 to about 200° C., preferably from about 75 to about 175° C., and more preferably from about 90 to about 150° C. The drying can be conducted for from about 0.5 to about 12 hr, preferably from about 1 to about 10 hr, more preferably from about 2 to about 8 hr, and still more preferably from about 3 to about 4 hr. The drying can be conducted to obtain a moisture content of less than or equal to 40 wt. %, preferably less than or equal to 30 wt. %, preferably less than or equal to 20 wt. %, and more preferably less than or equal to 10 wt. %. Alternatively, the drying can be conducted to obtain a water activity of less than or equal to 0.85, 0.50, 0.10, or 0.01 is obtained. The optimal temperature and time for drying can depend on the amount of meat, moisture content of the meat, surface area of the meat, and other factors.

The shredded meat can be seasoned to provide a desired taste. Thus, in some embodiments, the method further comprises adding a seasoning to the meat jerky, and the meat jerky further comprises a seasoning. In some embodiments, the meat jerky further comprises a seasoning selected from salt, sea salt, soy sauce, beef stock, barbecue, chili, chili lime, liquid smoke, garlic, habanero, hot sauce, sweet and spicy sauce, black pepper, pepper, vinegar, basil, cilantro, sugar, corn syrup, honey, chipotle, teriyaki, cheese, hydrolyzed vegetable protein, yeast extract, and combinations comprising at least one of the foregoing seasonings. The seasoning can be done at any point in the method for preparing the beef jerky. In some embodiments, the seasoning is added in the marinating step.

In some embodiments, the twice shredded meat is packaged after drying. The meat jerky can be sterilized by UV irradiation just prior to placing in individual packages. The packages can also be filled with an inert gas such as nitrogen to preserve freshness and prevent spoilage. The packaging can be done manually or can be automated.

In some embodiments of the method, the meat is cooked in an aqueous salt solution at a temperature of from about 90 to about 110° C., prior to shredding into shredded meat; the aqueous solution of acid and salt comprises from about 0.1 to about 5 g of the acid per kg meat; the shredded meat is marinated at a temperature of from about −10° C. to about 20° C.; the drying is conducted at a temperature of from about 60 to about 200° C.; and the meat jerky is packaged

A meat jerky that is at least one of crisp, crunchy, or friable is also disclosed herein. When a handful of the meat jerky is squeezed in the palm of one's hand, a distinct crackling sound is made, and the meat jerky breaks up into smaller fragments of fibers. Similarly, when eating, a distinct crunching sound is made, similar to the sound of squeezing the meat jerky in one's hand. The crispy, crunchy, or friable meat jerky can be produced by the method disclosed herein.

The crisp, crunchy, or friable quality of the meat jerky can also be measured quantitatively, for example, using an XTPlus Texture Analyzer, equipped with a TA-65 Multiple Puncture Rig. available from Texture Technologies Corp., Hamilton, MA. As described in the Example, the crunchiness is measured by counting the number of peaks (fractures) above a threshold value of 5 grams-force (0.04903 N) in a force-time graph, with data points collected over 6 s of compression at a rate of 5.00 mm/s. The number of fractures can be greater than 50, 60, 70, 80, 90, or 100. In some embodiments, the meat jerky provides a force-time graph having greater than or equal to 50 peaks, as measured using an XTPlus Texture Analyzer equipped with a TA-65 Multiple Puncture Rig with a compression of 30 mm at a rate of 5.00 mm/s for 6 s and with a peak threshold of 0.04903 N.

The meat jerky disclosed herein is high in protein and low in carbohydrates. The protein content, measured by the Kjeldahl method in accordance with AOAC 981.10 using a protein factor of 6.25, can be greater than or equal to 50, 60, 70, 80, or 90 wt. %, based on the total weight of the meat jerky. The protein content can also be 50 to 90 wt. %, 60 to 90 wt. %, 70 to 90 wt. %, or 80 to 90 wt. %, based on the total weight of the meat jerky. In some embodiments, the protein content is 50 to 90 wt. %, based on the total weight of the meat jerky, as measured by the Kjeldahl method in accordance with AOAC 981.10, using a protein factor of 6.25. Carbohydrate content is calculated by difference using the following equation:

$$Carbohydrates = 100 - ( Protein + moisture + fat + ash ) .$$

The carbohydrate content can be less than or equal to 50, 40, 30, 20, 10, 1, 0.1, or 0.01 wt. %, based on the total weight of meat jerky. In some embodiments, the carbohydrate content is less than 0.1 wt. %, based on the total weight of the meat jerky, as measured by difference from the combined protein, fat, moisture, and ash contents of the meat jerky.

Advantageously, the method for preparing meat jerky disclosed herein does not require chemical preservatives. In some embodiments, the meat jerky is free of or substantially free of a preservative(s), for example, monosodium glutamate, nitrates, nitrites, butylated hydroxyanisole (BHA), butylated hydroxytoluene (BHT), propyl gallate, citrate esters of monoglycerides, sodium erythorbate, cultured celery extract, and other preservatives. Specific examples of nitrites include sodium nitrite (NaNO₂) and potassium nitrite (KNO₂), and specific examples of nitrates include sodium nitrate (NaNO₃) and potassium nitrate (KNO₃, saltpeter). “Substantially free of”, as used herein, means that the preservative was not intentionally added to the meat jerky. “Substantially free of” also means that less than or equal to 1,000, 100, or 10 ppm of the preservative, based on the weight of the meat jerky, is present.

The meat jerky disclosed herein can have a fat content of greater than or equal to 7, 8, 9, or 10 wt. %, based on the total weight of the meat jerky, and less than or equal to 30, 20, or 15 wt. %, based on the total weight of the meat jerky. In some embodiments, the fat content is 7 to 30 wt. %, 8 to 20 wt. %, 9 to 15 wt. %, or 10 to 15 wt. %, based on the total weight of the meat jerky.

Advantageously, the meat jerky disclosed herein is high in protein. High in protein is defined herein as meat jerky having greater than or equal to 8, 10, 12, 15, 10, or 20 g of protein per ounce (28.35 g), as measured the Kjeldahl method in accordance with AOAC 981.10 using a protein factor of 6.25. In some embodiments, the meat jerky comprises 20 to 40 g of protein per ounce (28.35 g), or 20 to 30 g of protein per ounce (28.35 g), measured by the Kjeldahl method in accordance with AOAC 981.10 using a protein factor of 6.25. Advantageously, the meat jerky can also comprise low levels of at least one of sodium, fat, or carbohydrates. In some embodiments, the meat jerky is at least one of low in fat, low in sodium, or low in carbohydrates. “Low levels” of at least one of sodium, fat, or carbohydrates, as used herein, is defined as follows. The levels are defined as the amount present in one ounce (28.35 g) of meat jerky. A low level of sodium as defined herein refers to a sodium content of less than or equal to 1,000, 500, 400, 300, 200, or 100 milligrams per ounce (28.35 g) of meat jerky. A low level of fat as defined herein refers to a fat content of less than or equal to 10, 5, 3, 2, 1.5, or 1 g per ounce (28.35 g) of meat jerky. A low level of carbohydrates as defined herein refers to a carbohydrate content of less than or equal to 12, 10, 8, 6, 4, 2, 1, or 0.1 g per ounce (28.35 g) of meat jerky. The combination of being crisp, crunchy, and friable, being free of or substantially free of chemical preservatives, being high in protein, and being low in at least one of sodium, fat, or carbohydrates, provides a healthy and desirable alternative to fried snacks such as potato chips, tortilla chips, and the like. In some embodiments, the meat jerk comprises 20 to 30 g of protein.

This disclosure includes the following individual embodiments. Embodiments of the method are not mutually exclusive, and are independently combinable. Embodiments of the meat jerky are likewise not mutually exclusive and are independently combinable.

A method for preparing meat jerky comprises: (a) cooking a meat in an aqueous salt solution; (b) shredding the meat into a shredded meat; (c) marinating the shredded meat with an aqueous solution of acid and salt; (d) shredding the shredded meat a second time to form a twice shredded meat; and (e) drying the twice shredded meat.

In the method, the meat jerky prepared can be at least one of crisp, crunchy, or friable.

In the method, the meat jerky prepared can provide a force-time curve having greater than or equal to 50 peaks, as measured using an XTPlus Texture Analyzer equipped with a TA-65 Multiple Puncture Rig with a compression of 30 mm at a rate of 5.00 mm/s for 6 s and with a peak threshold of 0.04903 N.

In the method, the meat jerky prepared can have a protein content of 50 to 90 wt. %, based on the total weight of the meat jerky, as measured by the Kjeldahl method in accordance with AOAC 981.10 using a protein factor of 6.25.

In the method, the meat can be beef having less than 10 wt. % fat.

The method can further comprise, prior to mixing with an aqueous solution of acid and salt, separating at least a portion of fat and at least a portion of nerves from the shredded meat.

The method can further comprise adding a seasoning to the meat jerky.

The method can further comprise, after drying the twice shredded meat, packaging the twice shredded meat.

In the method, the meat can comprise a combination of short fibers of less than 5 cm in length and long fibers of 5 cm to about 10 cm in length.

In the method, the meat can be least one of beef round roll, silverside, leg of beef, topside, thick flank, tenderloin, chuck, shank, round, or sirloin.

In the method, the acid can be derived from a citrus fruit or other acidic fruit, or can be at least one of vinegar, acetic acid, citric acid, lactic acid, gluconic acid, succinic acid, tartaric acid, fumaric acid, ascorbic acid, pyrophosphoric acid, or salts thereof.

In the method, the meat can be cooked in an aqueous salt solution at a temperature of from about 90 to about 110° C.; the aqueous solution of acid and salt can comprise from about 0.1 to about 5 g of the acid per kg meat; the shredded meat can be marinated at a temperature of from about −10 to about 20° C.; the drying can be conducted at a temperature of from about 60 to about 200° C.; and the meat jerky can be packaged.

A meat jerky can be prepared by any combination of the above method embodiments.

A meat jerky is at least one of crisp, crunchy, or friable.

The meat jerky can provide a force-time graph having greater than or equal to 50 peaks, as measured using an XTPlus Texture Analyzer equipped with a TA-65 Multiple Puncture Rig with a compression of 30 mm at a rate of 5.00 mm/s for 6 s and with a peak threshold of 0.04903 N.

The meat jerky can have a protein content of 50 to 90 wt. %, based on the total weight of the meat jerky, as measured by the Kjeldahl method in accordance with AOAC 981.10 using a protein factor of 6.25.

The meat jerky can be free of or substantially free of monosodium glutamate, nitrates, nitrites, butylated hydroxyanisole (BHA), butylated hydroxytoluene (BHT), propyl gallate, citrate esters of monoglycerides, sodium erythrobate, cultured celery extract, and other preservatives.

The meat jerky can be at least one of low in sodium, low in fat, or low in carbohydrates.

The meat jerky can further comprise a seasoning selected from barbecue, chili, chili lime, liquid smoke, garlic, habanero, hot sauce, sweet and spicy sauce, black pepper, pepper, vinegar, basil, cilantro, sugar, corn syrup, honey, chipotle, teriyaki, cheese, hydrolyzed vegetable protein, and combinations comprising at least one of the foregoing seasonings.

### Examples

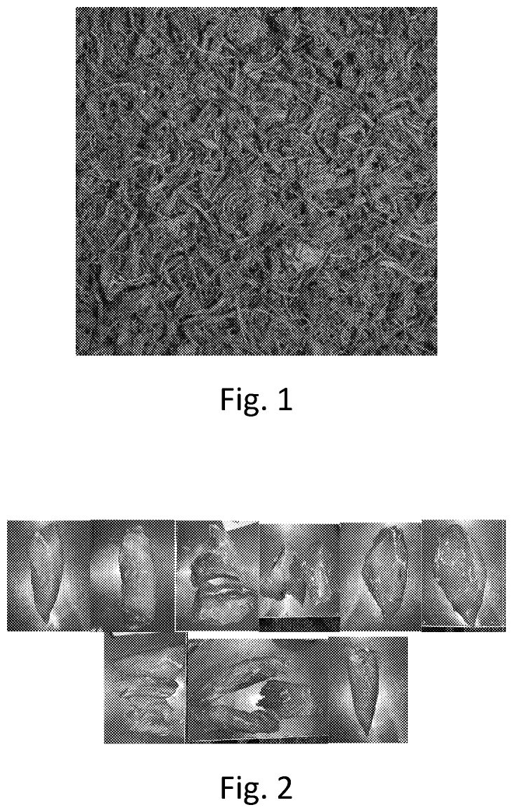

A general procedure for preparing the meat jerky is provided. One kilogram (kg) of a cut of beef with medium to long myofibrils selected from at least one of round roll, silverside, leg of beef, topside, thick flank, tenderloin, chuck, shank, round, sirloin is used. Examples of suitable cuts of beef are depicted in FIG. 2. The beef is boiled in brine for 6 to 7 hours. While still hot, the boiled beef is machine-shredded into individual fibers. Fat and nerves are separated from the beef and removed. The resulting beef is marinated with 32 g of a 1 to 3 wt. % solution of citric acid and 19 g of table salt for 10 to 12 hours in a refrigerator at −10 to 10° C. The resulting beef is then shredded a second time to properly separate it into individual fibers, and is spread onto perforated trays or a conveyor belt for drying. The beef is then dried in an oven for 3 to 4 hours at 90 to 150° C. The dried beef jerky, with medium and long fibers visible, is depicted in FIG. 1. The dried beef jerky is placed into individual packages after UV irradiation. The packages are optionally filled with an inert gas such as dry nitrogen. The packaging can be done manually or be automated. Qualitative characteristics of the meat jerky are summarized in TABLE 1 below.

TABLE 1
Qualitative Characteristics of Meat jerky

| Characteristic | Description |
|---|---|
| Color | Light brown to brown. |
| Appearance | Long, medium, and short fibers. |
| Smell and flavour | Taste of cooked meat, no acid taste, free |
| | from strong aromas. |
| Texture | Dry, crisp, crunchy, friable, not oily or |
| | chewy. |

Quantitative chemical properties of the meat jerky are summarized in TABLE 2. Test methods are those of AOAC International, Rockville, MD. Carbohydrate content is calculated by difference by the following equation:

$$Carbohydrates = 100 - ( Protein + moisture + fat + ash )$$

TABLE 2
Quantitative chemical properties of meat jerky

| | | | Result | | |
|---|---|---|---|---|---|
| | | | (wt. per | | |
| | | | ounce or | | |
| Characteristic | Result | | 28.35 g) | | Test Method |
| Protein-Kjeldahl ^{a} | 84.47 | wt. % | 23.95 | g | AOAC 981.10 |
| Fat ^{b} | 11.17 | wt. % | 3.167 | g | AOAC 933.05 |
| Ash-Dry ashing | 5.55 | wt. % | 1.673 | g | AOAC 920.153 |
| Moisture-forced | 2.60 | wt. % | 0.737 | g | AOAC 950.46 Bb |
| air oven | | | | | |
| Carbohydrates | <0.1 | wt. % | <0.028 | g | By difference |
| Sodium | 1880 | mg/100 g | 533.0 | mg | AOAC 984.27 |

| | | | |
|---|---|---|---|
| pH-10 wt. % | 5.89 | — | AOAC 981.12 |
| in water | | | |

^{a)} Calculated with protein factor of 6.25.
^{b)} By Mojonnier extraction with acid hydrolysis

As can be seen in Table 2, the meat jerky is high in protein—84.47 wt. % for the sample reported in Table 2. This is much higher than the protein content of many other commercial beef jerkies. Also, the meat jerky is low in carbohydrates—<0.1 wt. % for the sample reported in Table 2. This is much lower than the carbohydrate content of many other commercial beef jerkies.

### Crunchiness Measurements

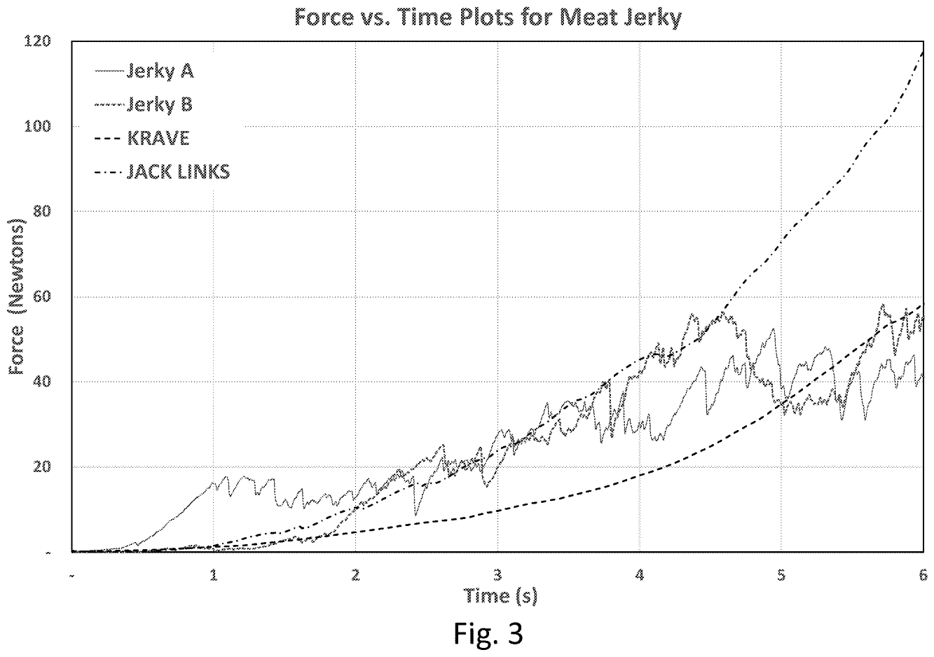

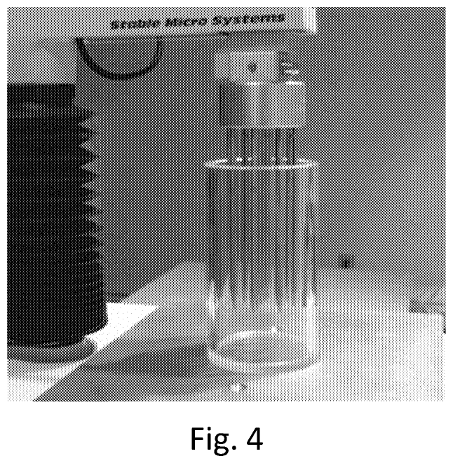

Crunchiness was measured quantitatively using an XTPlus Texture Analyzer equipped with a TA-65 Multiple Puncture Rig, available from Texture Technologies Corp., Hamilton, MA. The Multiple Puncture Rig has 13 tines or probes, and is depicted in FIG. 4. The probes are 0.152 in (3.86 mm) in diameter and taper to 0.055 in (1.32 mm) at the tip. Also depicted in FIG. 4 is the sample container, which is a plastic cylindrical vessel with an inner diameter of 75 mm and a height of 95 mm. Meat jerky samples are cut or shredded into small strips of similar size. The small strips are loaded into the vessel to a height of 45 mm. The TA-65 rig is positioned to the top of the meat jerky in the vessel and programmed in compression mode with a trigger force of 10 grams-force (0.09807 Newtons) and to descend 30 mm into the column of meat jerky at a rate of 5.00 mm/s, i.e. for a duration of 6 s. The opposing force from the meat jerky as a function of time is measured using a load cell and recorded. The results are expressed as plots of force in units of Newtons as a function of time, denoted as “force-time graphs” herein. The force-time graphs of four meat jerky samples, Jerky A (inventive), Jerky B (inventive), KRAVE (commercially available), and JACK LINK'S (commercially available) are reproduced in FIG. 3. As can be seen from FIG. 3, the graphs for the commercial controls were relatively smooth. However, the graphs for the inventive samples Jerky A and Jerky B are jagged. Each drop-off the curves represents a fracture in the meat jerky. The high degree of jaggedness of the graphs for Jerky A and Jerky B indicates high crunchiness, with the meat jerky fracturing frequently throughout the 6 s of the test. In contrast, relatively smooth curves were observed for the commercial samples, KRAVE and JACK LINK'S.

A macro called, “Jaggedness Macro (One Parameter)” was used to quantitatively measure the crunchiness of the samples. The macro is part of Exponent software, Version 6,1,20,0 by Stable Micro Systems, Surrey, UK, provided with the XTPlus Texture Analyzer. This macro was used to calculate the number of peaks, representing fractures. A threshold value of 5 grams-force (0.04903 Newtons) was selected, below which the fractures were not counted was used.

TABLE 3
Crunchiness of Meat jerky

| Sample | Fractures ^{a} |
|---|---|
| KRAVE | 41 |
| JACK LINK'S | 15 |
| Jerky A | 107 |
| Jerky B | 109 |

^{a} Measured at a threshold of 5 grams-force (0.04903N)

As can be seen from Table 3, Jerky A and Jerky B had significantly more measured fractures than the commercial samples, indicating much higher crunchiness.

Inspection of FIG. 3 also shows that although the Jerky A and Jerky B force-time graphs are jagged, the average force appears to level of at 6 s. In contrast, the slope of the force-time graphs for the commercial samples are positive, indicating that the maximum force was not yet reached at 6 s. These data indicate that the commercial samples are much harder than Jerky A and Jerky B.

“Myofibrils” and “fibers” are used interchangeably herein.

As used herein, table salt is sodium chloride, which optionally can contain sodium iodide (“iodized salt”).

“Substantially free of”, as used herein, means that the material in question was not added to the meat jerky. “Substantially free of” also means that less than or equal to 1,000, 100, or 10 ppm of the material, based on the weight of the meat jerky, is present. “Substantially free of” can also mean that none of the material can be detected by known analytical methods.

Various embodiments of the method of preparing meat jerky and the meat jerky prepared by the method are described herein with reference to the related drawings. Alternative embodiments can be devised without departing from the scope of this disclosure.

The following definitions and abbreviations are to be used for the interpretation of the claims and specification. As used herein, the terms “comprises”, “comprising”, “includes”, “including”, “has”, “having”, “contains”, “containing”, or any other variation thereof, are intended to be non-exclusive. In other words, a composition, a mixture, process, method, or article that comprises a list of elements is not necessarily limited to only those elements but can include other elements not expressly listed or inherent in such composition, mixture, process, method, or article. Additionally, the terms “exemplary” and “example” are used herein to mean “serving as an example, instance or illustration.” Any embodiment described herein as “exemplary” is not necessarily to be construed as preferred or advantageous over other embodiments. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. “At least one of” as used herein in connection with a list means that the list is inclusive of each element individually, as well as combinations of two or more elements of the list, and combinations of at least one element of the list with like elements not named.

References in the specification to “one embodiment,” “an embodiment,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it is submitted that it is within the knowledge of one skilled in the art to include such feature, structure, or characteristic in connection with other embodiments whether or not such combination is explicitly described.

The terms “about”, “substantially”, “approximately”, and variations thereof are intended to include the degree of error associated with measurement of the particular quantity based upon the equipment available at the time of filing the application. For example, “about” a given value can include a range of +10%, +5%, or +1% of the given value.

References to numerical ranges with lower and upper endpoints herein include all numbers subsumed within the range (including fractions), whether explicitly recited or not, as well as the endpoints of the range. Thus, “1 to 5” includes 1, 2, 3, 4, and 5 when referring to, for example, a number of elements, and can also include 1.5, 2, 2.75, 3.8, or any other decimal amount when referring to, for example, quantitative measurements.

While preferred embodiments of the method for preparing meat jerky and the meat jerky prepared by the method are described herein, those skilled in the art, both now and in the future, may make various improvements and enhancements which still fall within the scope of the claims which follow. Thus, these claims should be construed to encompass unnamed improvements and enhancements in the method of making meat jerky and the meat jerky prepared by the method.

What is claimed is:

1. A meat jerky, comprising a meat, wherein the meat jerky is at least one of crisp, crunchy, or friable and provides a force-time graph having greater than or equal to about 50 peaks, as measured using an XTPlus Texture Analyzer equipped with a TA-65 Multiple Puncture Rig with a compression of 30 mm at a rate of 5.00 mm/s for 6 s and with a peak threshold of 0.04903 N.

2. The meat jerky of claim 1, wherein the meat jerky is crisp, crunchy, and friable.

3. The meat jerky of claim 1, wherein the meat comprises chicken, beef, venison, lamb, goat, pork, turkey, duck, fish (e.g., tuna or salmon), alligator, ostrich, buffalo, pheasant, rabbit, veal, or elk.

4. The meat jerky of claim 1, wherein the meat comprises beef.

5. The meat jerky of claim 4, wherein the beef is beef round roll, silverside, leg of beef, topside, thick flank, tenderloin, chuck, shank, round, or sirloin.

6. The meat jerky of claim 1, wherein the meat comprises pork.

7. The meat jerky of claim 1, further comprising an acid and a salt.

8. The meat jerky of claim 7, wherein the acid is selected from acetic acid, citric acid, lactic acid, gluconic acid, succinic acid, tartaric acid, fumaric acid, ascorbic acid, pyrophosphoric acid, apple cider vinegar, blackcurrant vinegar, raspberry vinegar, quince vinegar, tomato vinegar, persimmon vinegar, jujube vinegar, wolfberry vinegar, kiwifruit vinegar, coconut vinegar, nipa palm vinegar, or balsamic vinegar, lemon juice, lime juice, orange juice, grapefruit juice, pineapple juice, tomato juice, or salts thereof.

9. The meat jerky of claim 7, wherein the meat jerky comprises about 0.1 g to about 10 g of acid per kg of meat.

10. The meat jerky of claim 7, wherein the salt is sodium chloride.

11. The meat jerky of claim 7, wherein the meat jerky comprises about 1 g to about 25 g of salt per kg meat.

12. The meat jerky of claim 1, further comprising a seasoning selected from salt, sea salt, beef stock, barbecue, chili, chili lime, liquid smoke, garlic, habanero, hot sauce, sweet and spicy sauce, black pepper, pepper, vinegar, basil, cilantro, sugar, corn syrup, honey, chipotle, teriyaki, cheese, hydrolyzed vegetable protein, yeast extract, and combinations comprising at least one of the foregoing seasonings.

13. The meat jerky of claim 1, wherein the meat jerky has a moisture content of less than or equal to about 10 wt. %.

14. The meat jerky of claim 1, wherein the meat jerky has a water activity of less than about 0.50.

15. The meat jerky of claim 1, wherein the meat jerky has a protein content of about 50 wt. % to about 90 wt. %, based on the total weight of the meat jerky, as measured by the Kjeldahl method in accordance with AOAC 981.10 using a protein factor of 6.25.

16. The meat jerky of claim 1, wherein the meat jerky is at least one of low in sodium, low in fat, or low in carbohydrates.

17. The meat jerky of claim 6, wherein the meat jerky contains about 7 wt. % fat to about 15 wt. % fat.

18. The meat jerky of claim 1, wherein the meat jerky has a carbohydrate content of less than about 1 wt. %, based on the total weight of the meat jerky, as measured by difference from the combined protein, fat, moisture, and ash contents of the meat jerky.

19. The meat jerky of claim 1, wherein the meat jerky is free of or substantially free of monosodium glutamate, nitrates, nitrites, butylated hydroxyanisole (BHA), butylated hydroxytoluene (BHT), propyl gallate, citrate esters of monoglycerides, sodium erythrobate, cultured celery extract, and other preservatives.

20. The meat jerky of claim 1, wherein the meat jerky is sterilized by UV irradiation and packaged.
